(19) United States
(12) Patent Application Publication
(10) Pub. No.: US 2016/0238721 A1
(43) Pub. Date: Aug. 18, 2016

(54) RELOCATION DETECTOR FOR DETECTING RELOCATION OF APPARATUS

(71) Applicant: FANUC Corporation, Minamitsuru-gun (JP)

(72) Inventors: Kouhei YOSHIDA, Minamitsuru-gun (JP); Yutaka SAKAI, Minamitsuru-gun (JP)

(21) Appl. No.: 15/040,150

(22) Filed: Feb. 10, 2016

(30) Foreign Application Priority Data
Feb. 16, 2015 (JP) 2015-27175

(51) Int. Cl. G01V 1/16; G01H 11/06

(52) U.S. Cl. CPC G01V 1/164; G01H 11/06

(57) ABSTRACT

Disclosed is a relocation detector mounted on an apparatus and configured to detect relocation of the apparatus and limit functions of the apparatus. The relocation detector includes a vibration power generation unit configured to convert a vibration to electrical energy. The relocation of the apparatus is detected by the electrical energy from the vibration power generation unit, which serves as a power source for the relocation detector, generated by the vibration of the apparatus.

### BACKGROUND OF THE INVENTION

1. Field of the Invention

The present invention relates to a relocation detector mounted on an apparatus that is prohibited from being improperly relocated from a predetermined installation place to another place and configured to detect relocation of the apparatus.

2. Description of the Related Art

The export of machine tools that may possibly be used for the development of weapons of mass destruction or the like and high-precision or high-function apparatuses is strictly controlled to prevent illegal export. However, it is difficult to prevent these apparatuses once exported abroad from being relocated by third parties to those countries to which export is prohibited. Accordingly, these apparatuses are incorporated with mechanisms for detecting their unpermitted relocation, if any, from their installation positions and preventing the apparatuses from resuming operations.

However, false detection due to earthquakes cannot be avoided by simply detecting vibrations applied to the apparatuses during relocation and determining the execution of the apparatus relocation based on the result of the detection. Accordingly, there has been proposed a method in which relocation of an apparatus is determined by detecting the orientation of the apparatus by means of a gyro sensor previously mounted thereon, since the orientation of the apparatus changes as the apparatus is relocated (Japanese Patent Application Laid-Open No. 2007-334395). In another proposed method, relocation of an apparatus is detected by means of a pressure sensor previously mounted on the apparatus, based on changes of atmospheric pressure data caused by the movement of the relocated apparatus (Japanese Patent Application Laid-Open No. 2009-266101). Further, there is a known technique in which the execution of relocation of a numerical controller is detected by analyzing digital data on an acceleration signal detected by an acceleration sensor previously mounted on the numerical controller, since the detected acceleration signal changes as the numerical controller is moved to be relocated (Japanese Patent Application Laid-Open No. 2009-187234).

FIG. 3 is a schematic diagram of a conventional relocation detector for detecting relocation of an apparatus. A relocation detector 10 comprises a relocation detection unit 16, a battery 17 for supplying electric power to the relocation detection unit 16, and a charging circuit 18 for charging the battery 17. The relocation detection unit 16 mainly comprises a sensor 11, ND converter 12, microprocessor unit (MPU) 13, memory 14, and input/output interface 15. The sensor 11 comprises a gyro sensor, pressure sensor, acceleration sensor, and the like and serves to detect relocation of the apparatus. The ND converter 12 digitizes analog data output from the sensor 11. The MPU 13 processes digital data retrieved from the ND converter 12. The memory 14 is a flash memory or the like that holds the data processed by the MPU 13 and processing software to be executed by the MPU 13. The input/output interface 15 serves for communication with a control unit of an apparatus 20 such as a machine tool.

The relocation detector 10 is incorporated in the apparatus 20 that is prohibited from being relocated without prescribed permission after the machine tool and various pieces of equipment are once installed. This relocation detector 10 is used to detect the movement of the apparatus 20 during relocation, thereby detecting the relocation of the apparatus 20. When the apparatus 20 is activated by a power source, the battery 17, e.g., a secondary battery, is charged with electricity through the charging circuit 18 based on the power source, and electric power is supplied from the battery 17 to the relocation detector 10. Based on data obtained by digitizing detection signals received from the sensor 11 through the ND converter 12, the MPU 13 performs processing for detecting the relocation of the apparatus.

The power supply to the apparatus 20 is stopped while the apparatus 20 is being relocated. Since the relocation detection unit 16 is supplied with electric power from the battery 17, however, the processing for the apparatus relocation detection by the relocation detector 10 is continued. If the apparatus 20 is moved to be relocated, the output signals of the sensor 11 (comprising the gyro sensor, pressure sensor, acceleration sensor, etc.) change according to the movement of the apparatus 20. The MPU 13 analyzes the output signals by the processing software stored in the memory 14 to determine the execution of the movement of the apparatus 20. If the movement is detected, the MPU 13 transmits signals for limiting the functions of the apparatus 20 (e.g., for prohibiting startup) to the control unit of the apparatus 20. In this way, the functions of the apparatus 20 can be limited if the apparatus 20 is improperly relocated.

The conventional apparatus relocation detector is configured to detect the movement of the machine tool or some other apparatus on which the relocation detector is mounted by means of the sensor comprising the gyro sensor, pressure sensor, acceleration sensor, and the like, and to detect the apparatus relocation based on detection signals obtained by the detection. It is necessary, therefore, to supply electrical energy to the relocation detector. On the other hand, the power supply to the apparatus is interrupted while the apparatus is being relocated. Thus, according to the prior art techniques, the battery is provided in the relocation detector, whereby the apparatus relocation can be detected in such a manner that the battery is stored with electricity during the operation of the apparatus and that electric power is supplied from the battery during the relocation without the power supply to the apparatus.

If the apparatus to be relocated is one that has not been used for a long time, however, it may be dead having failed to be charged, so that the apparatus relocation cannot be well detected. In consideration of safety or prevention of improper relocation of the apparatus, therefore, the apparatus is expected to have the function of forcibly preventing itself from moving when the remaining battery capacity is insufficient.

### SUMMARY OF THE INVENTION

Accordingly, the object of the present invention is to provide a relocation detector for detecting relocation of an apparatus, capable of preventing interruption of power supply to the relocation detector during the relocation of the apparatus so that the apparatus relocation can be detected and functions of the apparatus can be limited despite prolonged interruption of power supply to the apparatus.

In a relocation detector according to the present invention, which is mounted on an apparatus and configured to detect relocation of the apparatus and limit functions of the apparatus, a vibration power generation unit configured to convert a vibration to electrical energy is provided in place of the charging unit and the battery of the conventional relocation detector. The relocation of the apparatus is detected by the electrical energy from the vibration power generation unit, which serves as a power source for the relocation detector, generated by the vibration of the apparatus.

In a relocation detector according to the present invention, which is mounted on an apparatus and configured to detect relocation of the apparatus and limit functions of the apparatus, a vibration power generation unit configured to convert a vibration to electrical energy is additionally provided without omitting the charging unit and the battery of the conventional relocation detector. The battery is charged with the output electrical energy of the vibration power generation unit by charging unit and the relocation of the apparatus is detected by using an output of the battery as a power source for the relocation detector.

According to the present invention constructed as described above, the apparatus installed in place must be moved if it is to be relocated. As it is moved, the apparatus vibrates so that the vibration power generation unit generates the electrical energy, which activates the relocation detector. Therefore, the relocation detector can detect the relocation of the apparatus even when the power of the apparatus is off. Thus, there is no possibility of the relocation detector, unlike the conventional one, being cut off from the power supply due to battery exhaustion or the like and hence failing to detect the apparatus relocation. Further, the use of the power generation unit obviates the use of the battery and the charging unit, so that an increase in circuit scale can be prevented to achieve wire saving.

### BRIEF DESCRIPTION OF THE DRAWINGS

The above and other objects and features of the present invention will be obvious from the ensuing description of embodiments with reference to the accompanying drawings, in which:

FIG. 1 is a schematic diagram of a relocation detector according to a first embodiment of the present invention;

FIG. 2 is a schematic diagram of a relocation detector according to a second embodiment of the present invention; and

FIG. 3 is a schematic diagram of a conventional relocation detector.

### DETAILED DESCRIPTION OF THE PREFERRED EMBODIMENTS

Conventionally, an attempt has been made to effectively use electrical energy that is obtained by conversion of vibrations of roads, bridges, buildings, industrial machines, etc., vibrations caused by artificial external forces, such as vibrations of automobiles, railway vehicles, and aircraft, environmental vibrations caused by natural external forces such as earthquakes and winds, and the like. Vibration power generation is a generally known power generation system in which vibrational energy is converted to electricity. Vibration power generation means for such vibration power generation will hereinafter be referred to as a vibration power generator.

The present invention is configured to use this vibration power generator, which generates electrical energy by means of vibrations generated when an apparatus such as a machine tool is relocated. A relocation detector is operated by using the generated electrical energy so that the relocation of the apparatus on which the relocation detector is mounted can be detected.

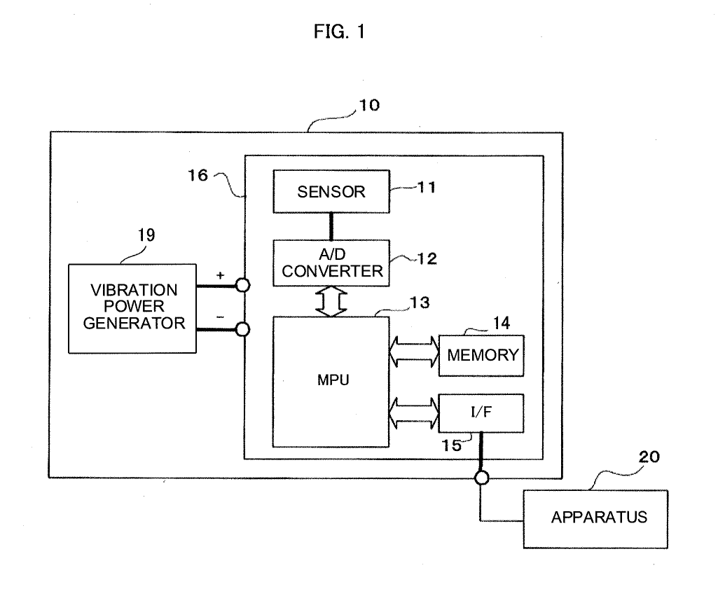

FIG. 1 is a schematic diagram of a relocation detector according to a first embodiment of the present invention. A relocation detector 10 of this first embodiment uses a vibration power generator 19 in place of the battery 17 and the charging circuit 18 of the conventional relocation detector shown in FIG. 3, and the vibration power generator 19 serves as a power source for the relocation detector 10. For other configurations, the relocation detector 10 is constructed in the same manner as the conventional one. Further, this relocation detector 10 is mounted on an apparatus 20 that is prohibited from being relocated from the place in which the machine tool and the various pieces of equipment are installed. A control unit of the apparatus 20 and the relocation detector 10 are electrically connected to each other.

The vibration power generator 19 is connected to a power input/output terminal of a relocation detection unit 16 of the relocation detector 10. Electrical energy generated by the vibration power generator 19 is supplied as operating energy for the relocation detection unit 16.

If the apparatus 20 installed in place is moved to be relocated, vibrations are generated in the apparatus 20 and the relocation detector 10 during the movement. Based on these vibrations, the vibration power generator 19 generates electrical energy, which is delivered to the relocation detection unit 16.

As the apparatus 20 and the relocation detector 10 are moved, on the other hand, output signals of a sensor 11, which comprises a gyro sensor, pressure sensor, acceleration sensor, etc., and serves to detect the movement for relocation of the apparatus 20, change. Digital data obtained by converting the output signals of the sensor 11 to digital values by an ND converter 12 are analyzed by processing software stored in a memory 14 to detect the movement of the apparatus 20 (and the relocation detector 10). An apparatus relocation signal is transmitted to the control unit of the apparatus 20 through an input/output interface 15 so that the function of the apparatus 20 to prevent startup of the apparatus 20 and other functions are limited.

According to this first embodiment, the relocation detector 10 requires neither a battery nor a charging circuit, so that an increase in circuit scale can be prevented to achieve wire saving.

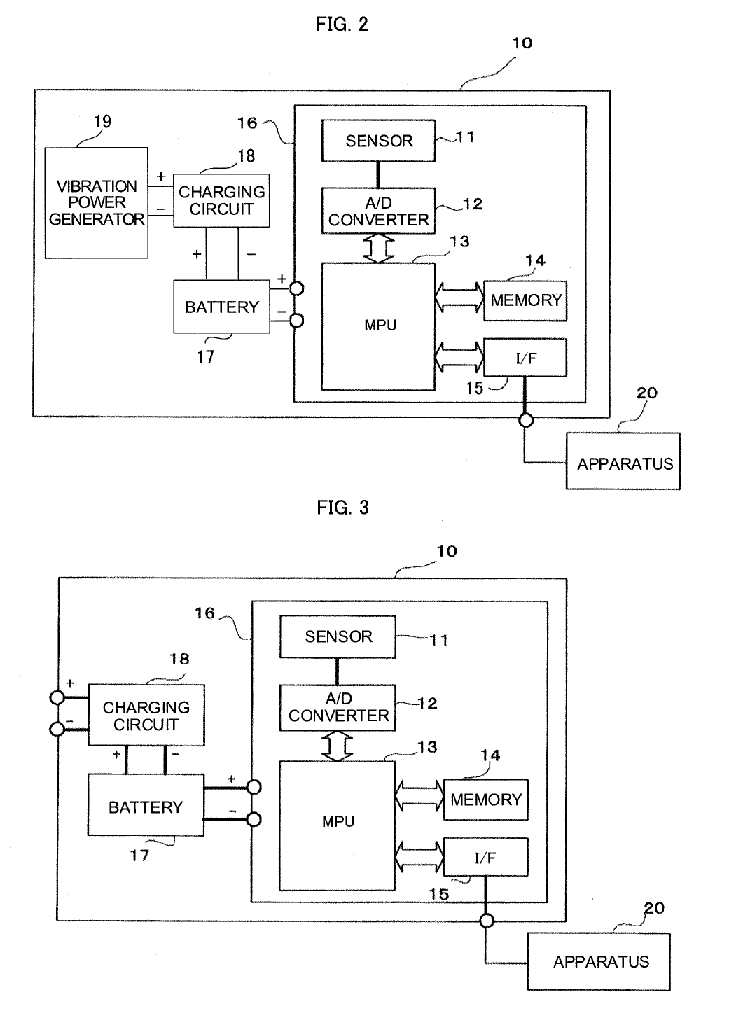

FIG. 2 is a schematic diagram of a relocation detector according to a second embodiment of the present invention.

This second embodiment is based on the conventional relocation detector of FIG. 3 additionally provided with a vibration power generator 19, which serves as an input power source for a charging circuit 18.

This relocation detector 10 is mounted on an apparatus 20 that is prohibited from being relocated. While the apparatus 20 is operating, the vibration power generator 19 generates electrical energy based on vibrations from the apparatus 20, a battery 17, which comprises a secondary battery, capacitor, etc., is charged with the electrical energy through the charging circuit 18, and electric power is supplied from the battery 17 to a relocation detection unit 16. Thus, in this second embodiment, the vibration power generator 19, charging circuit 18, and battery 17 constitute a power source for the relocation detector 10. If the apparatus (including the relocation detector 10) 20 is moved to be relocated, moreover, the vibration power generator 19 generates electrical energy based on vibrations of the apparatus 20 due to the movement thereof and the like, thereby charging the battery 17, even when the apparatus 20 is powered off. Since the power supply to the relocation detection unit 16 is continued even during the relocation of the apparatus 20, therefore, the relocation detection unit 16 operates so that the MPU 13 determines the execution of the relocation of the apparatus based on the detection output of the sensor 11, as in the conventional example shown in FIG. 3 and the first embodiment shown in FIG. 1. If the relocation (or movement) is detected, an apparatus relocation signal is transmitted to a control unit of the apparatus 20 through an input/output interface 15 so that the function of the apparatus 20 to prevent startup of the apparatus 20 and other functions are limited.

1. A relocation detector mounted on an apparatus and configured to detect relocation of the apparatus and limit functions of the apparatus, the relocation detector comprising:
a vibration power generation unit configured to convert a vibration to electrical energy,
wherein the relocation of the apparatus is detected by the electrical energy from the vibration power generation unit, which serves as a power source for the relocation detector, generated by the vibration of the apparatus.

2. A relocation detector mounted on an apparatus and configured to detect relocation of the apparatus and limit functions of the apparatus, the relocation detector comprising:
a vibration power generation unit configured to convert a vibration to electrical energy,
wherein a battery is charged with the output electrical energy of the vibration power generation unit by charging unit and the relocation of the apparatus is detected by using an output of the battery as a power source for the relocation detector.
